(19) United States
(12) Patent Application Publication
(10) Pub. No.: US 2008/0312929 A1
(43) Pub. Date: Dec. 18, 2008

(54) USING FINITE STATE GRAMMARS TO VARY OUTPUT GENERATED BY A TEXT-TO-SPEECH SYSTEM

(75) Inventors: OSCAR J. BLASS, BOYNTON BEACH, FL (US); PARITOSH D. PATEL, PARKLAND, FL (US); HARVEY M. RUBACK, LOXAHATCHEE, FL (US); ROBERTO VILA, HOLLYWOOD, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/761,852

(22) Filed: Jun. 12, 2007

(51) Int. Cl. G10L 13/00

(52) U.S. Cl. 704/260; 704/258; 704/E13.006; 704/E13.011

(57) ABSTRACT

The present invention discloses a text-to-speech system that provides output variability. The system can include a finite state grammar, a variability engine and a text-to-speech engine. The finite state grammar can contain a phrase role consisting of one or more phrase elements. The phrase rule can deterministically generate a variable text phrase based upon at least one random number. The phrase rule can include a definition for each of the phrase elements. Each definition can be associated with at least one defined text string. The variability engine can construct a random text phrase responsive to receiving an action command, wherein said finite state grammar is used to create the text phrase. The variability engine can also rely on user-specified weights to adjust the output probabilities. The speech-to-text engine can convert the text phrase generated by the variability engine into speech output.

### BACKGROUND

1. Field of the Invention

The present invention relates to the field of text-to-speech processing and, more particularly, to using finite state grammars to vary the output generated by a text-to-speech system.

2. Description of the Related Art

Text-to-speech (TTS) systems are an integral component of speech processing systems. In conventional TTS systems, the system synthesizes speech from a text string. This creates a one-to-one correlation between text strings and speech output. Such a rigid system does not easily allow for variances in speech output for a common or repeating event. That is, the same text string is used to generate the same speech output every time a triggering event occurs. For example, every time the phone rings, the TTS system generates the speech output “The phone is ringing”.

This repetitive nature perpetuates the perception that speech systems using TTS are cold and impersonal, lacking the natural language variances characteristic of human interaction. People typically vary their wording while retaining meaning, even when experiencing redundant events. Expanding on the above example, a person may say phrases like “Phone call,” “Get the phone.” or “You have a phone call.”

From an implementation standpoint, adding such variability to a conventional TTS system requires additional code for each distinct phrase to be added to the text processing engine. The more variability in phrasing desired, the more code required. This additional code must be traversed by the processing engine every time speech output is required, reducing processing speed and increasing output delay, it further adds to a size of code and increases a corresponding memory space needed for the code. Additionally, variances produced by such a hard-coding method are predictable, which causes a perception of robot responses instead of the more humanistic interactions that are desired.

What is needed is a solution that increases speech variability in a TTS system without degrading system performance. That is, the system would mimic human interactivity by allowing for a variety of speech output to be produced for the same triggering event. Ideally, such a system would leverage existing system resources.

### SUMMARY OF THE INVENTION

The present invention discloses a technique of integrating finite state grammars and a speech synthesis engine to vary output of a speech generation process in a humanistic fashion. That is, a general command can be associated with a finite state grammar. This finite state grammar can map the generic command to a set of variable phrase elements able to be combined with each other. A randomizing factor can determine which of the selectable phase elements of the finite state grammar are selected. In one embodiment, a set of weights can be established to prefer certain phrase element choices over others. Each time the general command is issued, a different resultant phrase can be produced by the finite state grammar in a non-predictable manner. This resultant phrase, which is a concatenation of the selected finite state grammar phrase elements, can be speech synthesized and audibly presented as output. Accordingly, the invention provides a concise technique for varying generated speech responses to simulate variable responses characteristic of human-to-human interactions.

The present invention can be implemented in accordance with numerous aspects consistent with the material presented herein. For example, one aspect of the present invention can include a speech synthesis method that includes a step of receiving a command for generating speech. One of many finite state grammars can be determined, where the determined grammar is associated with the received command. The finite state grammar can include a set of two or more phrase elements. Each element can correspond to a one or more different text strings. At least one number can be randomly generated. This number can be used to select one of the different text strings for each of the phrase elements. The selected text strings can be concatenated in an order defined by the finite grammar. The concatenated text strings can be text-to-speech converted to produce synthesized speech output.

Another aspect of the present invention can include a method for using a finite state grammar to vary output of a text-to-speech system. In the method, a text-to-speech system can receive an action command. A finite state grammar can be accessed that corresponds to the received action command. A text phrase can he constructed using the finite state grammar. The text phrase can be text-to-speech converted to generate speech output.

Still another aspect of the present invention can include a text-to-speech system that provides output variability. The system can include a finite state grammar, a variability engine, and a text-to-speech engine. The finite state grammar can contain a phrase rule consisting of one or more phrase elements. The phrase rule can deterministically generate a variable text phrase based upon at least one random number. The phrase rule can include a definition for each of the phrase elements. Each definition can be associated with at least one defined text string, which are combined to generate the variable text phrase. The variability engine can construct a random text phrase responsive to receiving an action command, wherein said finite state grammar is used to create the text phrase. The speech-to-text engine can convert the text phrase generated by the variability engine into speech output.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, any other recording medium, or can also be provided as a digitally encoded signal conveyed via a carrier wave. The described program can be a single program or can be implemented as multiple subprograms, each of which interact within a single computing device or interact in a distributed fashion across a network space.

The method detailed herein can also be a method performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram of a system for utilizing finite state grammars to vary speech output of a text-to-speech system in accordance with embodiments of the inventive arrangements disclosed herein.

FIG. 2 is a schematic diagram illustrating the internal components of a variability engine in accordance with an embodiment of the inventive arrangements disclosed herein.

FIG. 3 depicts a sample grammar, action command, weighting data, and examples that illustrate the interaction of these elements to generate varied speech output in accordance with an embodiment of the inventive arrangements disclosed herein.

FIG. 4 is a flow diagram illustrating a method for varying the speech output of a text-to-speech (TTS) system in accordance with an embodiment of the inventive arrangements disclosed herein.

### DETAILED DESCRIPTION OF THE INVENTION

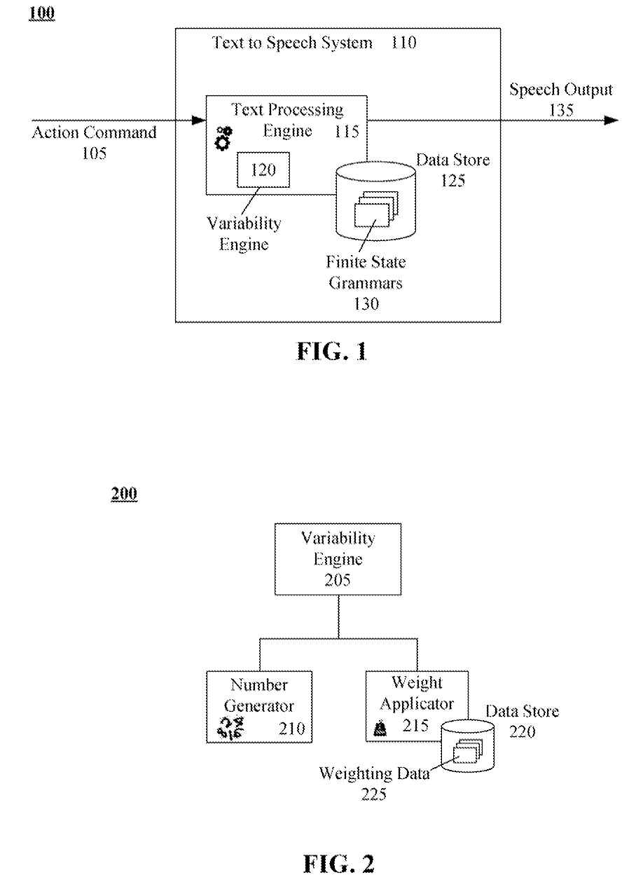

FIG. 1 is a schematic diagram of a system 100 for utilizing finite state grammars 130 to vary speech output 135 of a text-to-speech system 110 in accordance with embodiments of the inventive arrangements disclosed herein. In system 100, the text-to-speech (TTS) system 110 can accept an action command 105 which, when processed, produces speech output 135. The speech output 135 can vary from execution-to-execution to simulate variability typical of human-to-human interactions. Randomness can be produced using a variability engine 120 configured to generate random or pseudorandom numbers, which cause the finite state grammars 130 that produce the speech output 135 to produce non-predictable results.

In system 100, the text-to-speech system 110 can be any set of programmatic instructions stored in a machine readable memory, which cause the machine to produce the speech output 135 responsive to receiving the action command 105. The TTS system 110 can be a stand-alone program or can be a component of a larger computing system. For example, in one embodiment, the TTS system 1100 can be a component of a speech-enabled navigation system. In another example, the TTS system can he a TTS engine of a turn-based speech processing system implemented in a middleware environment.

The action command 105 can be a string of alphanumeric characters, which can be provided by a component of a speech processing system provided by an auxiliary computing device or software component, and/or provided as manual input to the system 110. The action command 105 can correspond to an event occurrence experienced by its sender and/or the requested speech output 135. For example, an action command 105 of “REPEAT_SPEECH” can be passed to the TTS system 110 from a speech recognition component that was unable to recognize received speech from a caller.

It should be noted that the action command 105 does not include a text string that is directly converted into speech output 135 as with conventional TTS systems. Rather, the action command 105 is mapped to a finite state grammar 130, which generates a text string, which a TTS engine converts into the speech output 135. For example, the action command 105 “REPEAT_SPEECH” can cause the grammar 130 to generate an output string of “I don't understand, could you please repeat that phrase”; which is converted to speech to produce output 135.

The TTS system 110 can utilize a text processing engine 115 and data store 125. The TTS system 110 can include numerous other traditional components (not shown) for producing speech output 135, such as a phonetizer and synthesizer, which have been omitted from FIG. 1 for brevity. In other words, the variability engine 120 and the finite state grammars 130 of data store 125 are non-traditional components of a text processing engine 115 unique to the disclosed solution.

The variability engine 120 can be a software component that executes code to interject variances in the composition of the speech output 135 produced for the action command 105. In order to create variances in the speech output 135, the variability engine 120 can access a finite state grammar 130 contained within the data store 125. The finite state grammar 130 can be a concise definition of the possible phrase combinations meant to be produced as speech output 135 in response to receiving the action command 105.

It should be noted that the utilization of a finite state grammar 130 to interject variability into phrase construction can produce less strain on the TTS system 110 than attempting to enable such variability in a conventional TTS system. Additionally, since many comprehensive speech processing systems already utilize finite state grammars for speech recognition, it can be possible to leverage these existing speech assets.

FIG. 2 is a schematic diagram 200 illustrating the internal components of a variability engine 205 in accordance with an embodiment of the inventive arrangements disclosed herein. The variability engine 205 of diagram 200 can be used within the context of system 100 or any other text-to-speech (TTS) system that uses finite state grammars to produce variable speech output.

The variability engine 205 can include a number generator 210 and weight applicator 215. The number generator 210 can be a component used to generate numbers for the textual elements of the phrase defined within a finite state grammar. Number generation can be achieved in a multitude of manners, including, but not limited to noise synthesis, a pseudo-random number generation algorithm, a quasi-random number generation algorithm, a static set of numeric values, and the like.

The weight applicator 215 can be a software component that executes code to adjust the textual elements selected to comprise the phrase for speech output based upon predefined weights. The weight applicator 215 can utilize the numbers generated by the number generator 210 and the weighting data 225 contained within data store 220 to determine die need for adjustments.

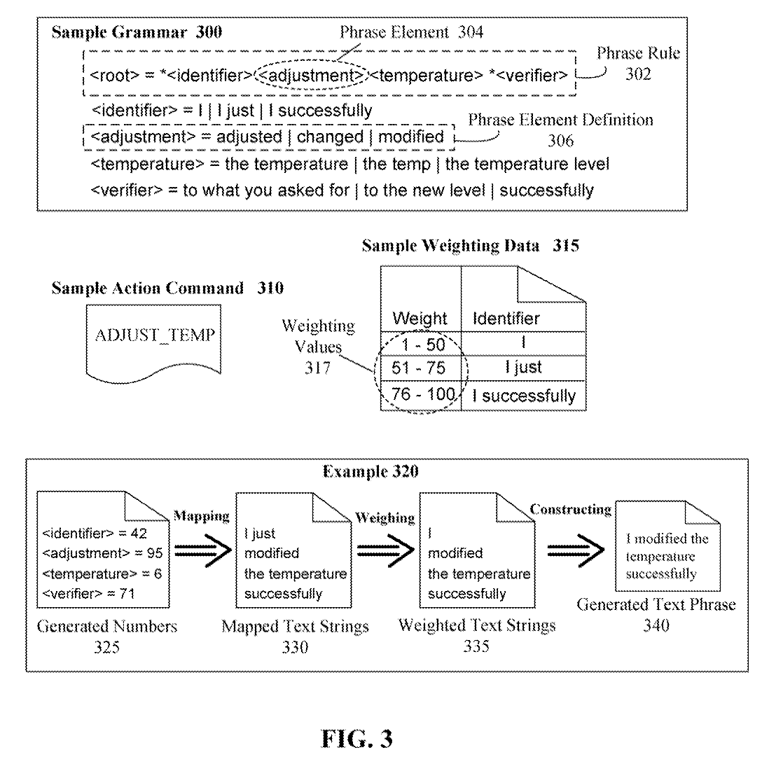

FIG. 3 depicts a sample grammar 300, action command 310, weighting data 315, and examples 320 and 340 that illustrate the interaction of these elements to generate varied speech output in accordance with an embodiment of the inventive arrangements disclosed herein. The elements shown in FIG. 3 can be used in the context of system 100 or any other text-to-speech (TTS) system that uses finite state grammars to produce variable speech output. It should be stressed that the samples shown in FIG. 3 are for illustrative purposes and are not intended to represent an absolute implementation or limitation to the present invention.

The sample grammar 300 can define a phrase to be converted into speech output for a TTS system. Definition of the phrase can be represented by a phrase rule 302, which can be written in the syntax of Baehus-Naur Format (BNF) as a regular expression. The invention is not limited to BNF and other regular expression syntax can be used. The phrase rule 302 can include one or more phrase elements 304.

Each phrase element 304 can represent a logical block of text for the phrase being produced by the grammar 300. It should be noted that a phrase element 304 is not equivalent to text constructs used to create sentences within the English language. That is, a phrase element 304 need not define a subject, verb, predicate, clause, and the like. The phrase element 304 can represent any grouping of text that the grammar author desires to vary in when generating the speech output. In this example, the phrase rule 302 contains four phrase elements 304—<identifier>, <adjustment>, <temperature>, and <verifier>.

Text strings can be associated with each phrase element 304 of the phrase rule 302 in a phrase element definition 306. The phrase element definition 306 can represent the acceptable text string values for the specified phrase element 304. As shown in this example, the definition 306 for the phrase element 304 <adjustment> includes the text strings “adjusted”, “changed”, and “modified”. Therefore, the speech output produced by this grammar 300 can contain any of these three values.

It should be noted that the sample grammar 300 shown in this example can produce eighty-one distinct phrases for speech output. This further illustrates the superiority of this approach over conventional means of speech output variance. A conventional TTS system would require a control structure within its processing code to accommodate each of the eighty-one possibilities, whereas this approach requires only five lines of a finite state grammar 300. Additionally, the contents of the grammar 300 can be re-used for multiple action commands, much like concept of reuse within the object-oriented programming paradigm.

The sample grammar 300 can have a sample action command 310 and sample weighting data 315 associated with it. In this example, the sample action command 310 to generate speech output using grammar 300 is “ADJUST_TEMP.” The sample weighting data 315 can include a weighting value 317 for each text string value of a phrase element definition 306. By using weighting data 315, preferences can be given to the text string values of a phrase element definition 306. The sample weighting data 315 in this example is shown for the phrase element <identifier>.

Example 320 can illustrate the use of the sample grammar 300 and weighting data 315 by a variability engine to produce a phrase for speech output. While example 320 encompasses all the elements 304 of the grammar 300, the phrase element 304 <identifier> will be highlighted as a specific example. A set of generated numbers 325 can he produced, where each number in the set corresponds to a phrase element 304 (e.g., the number generated for <identifier> is forty-two). The numbers can be generated by a number generation component of the variability engine, such as number generator 210 of engine 205.

The variability engine can then use an algorithm to map each of the numbers to a specific text string value of the phrase element definition 306 to produce a set of mapped text strings 330. For this example, the variability engine maps the numbers based on dividing one hundred by the quantity of text string values in the phrase element definition 306. The definition 306 for <identifier> contains three possible text string values. Therefore, the string “I” will be selected when the number is in the range one to thirty-three, “I just” between thirty-four and sixty-six, and “I successfully” for sixty-seven to one hundred. Thus, a generated number three hundred and twenty five of forty-two for <identifier> maps to the text string value “I just,” as shown in the set of mapped text strings 330.

The weighting data 315 can then be applied to the set of mapped text strings 330. Since only weighting data 315 for <identifier> exists in this example, only the <identifier> text string can be modified, line application of weighting data 315 can take a variety of forms. In this example, the generated number hundred and twenty five of forty-two for <identifier> can be compared against the weighted values 317 of the weighting data 315. The value forty-two falls within the range of the first range of weighted values 317. This can result in the mapped text string 330 value for <identifier> being replaced with the text string value associated with the applicable weighted value 317, as shown in the set of weighted text strings 335.

Once weighting is complete, the variability engine can use the text strings to construct a text phrase 340. The generated text phrase 340 can then be synthesized into speech output and conveyed to the listener.

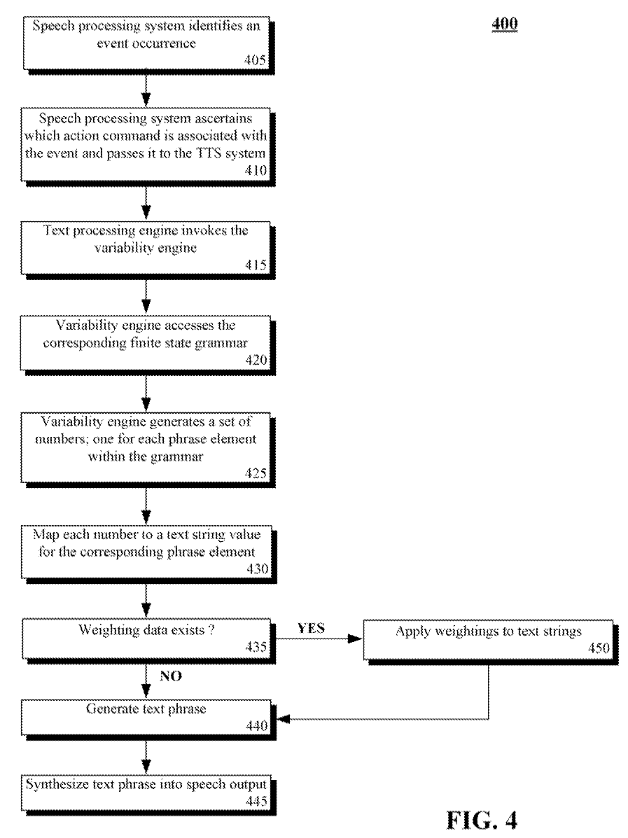

FIG. 4 is a flow diagram illustrating a method 400 for varying the speech output of a text-to-speech (TTS) system in accordance with an embodiment of the inventive arrangements disclosed herein. Method 400 can be performed within the context of system 100 and/or utilizing the elements described in FIG. 2 and/or FIG. 3,

Method 400 can begin with step 405 where a speech processing system identifies an event occurrence. Event occurrences can correspond to interactions among components of the speech processing system (e.g., speech recognition and TTS components) as welt as interaction between a user and the speech processing system (e.g., a person using an interactive voice response (IVR) component).

In step 410, the speech processing system can ascertain the action command associated with the event occurrence and can convey the action command to the TTS system. The text processing engine of the TTS system can invoice the variability engine in step 415. In step 420, the variability engine can access the finite state grammar associated with the action command,

The variability engine can generate a set of numbers, one for each phrase element within the grammar, in step 425. In step 430, the set of numbers can be mapped to text string values for the phrase elements. The existence of weighting data can be determined in step 435. When weighting data exists, step 450 can execute in which the weightings can be applied to the text strings.

In the absence of weighting data, step 440 can execute in which a text phrase can be generated from the text strings. The text phrase can be synthesized into speech output in step 445.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method for using a finite state grammar to vary output of a text-to-speech system comprising:
a text-to-speech system receiving an action command;
accessing a finite state grammar that corresponds to the received action command;
constructing a text phrase based on the finite state grammar; and
synthesizing the constructed text phrase into speech output.

2. The method of claim 1, wherein the constructing step further comprises:
generating a numeric value;
mapping the generated numeric value to a text string for a phrase element of the finite state grammar;
selecting the corresponding text string for use in the text phrase;
determining an existence of weighting data for the phrase element, wherein the weighting data represents a set of predefined selection preferences that correspond to the text strings associated with the phrase element; and
when weighting data exists, applying the weighting data to the phrase element.

3. The method of claim 2, wherein the applying step further comprises:
comparing the generated numeric value against the set of predefined selection preferences, wherein the set of selection preferences contains one or more weighted values;
determining which weighted value corresponds to the generated numeric value;
ascertaining an equivalency between the text string associated with the weighted value and the previously selected text string; and
when the result of the ascertaining step indicates inequality, replacing the previously selected text string with the text string associated with the weighted value.

4. The method of claim 3, wherein the weighted value is one of a numeric value and a range of numeric values.

5. The method of claim 2, wherein the generating step utilizes an algorithm to produce a pseudo-random number.

6. The method of claim 2, wherein the steps of claim 2 are repeated for each phrase element defined within the finite state, grammar.

7. The method of claim 1, wherein the finite state grammar defines a phrase rule for the text phrase, wherein the phrase rule describes an order for linking one or more phrase elements, and wherein the finite state grammar defines a set of acceptable text strings for each phrase element.

8. The method of claim 1, wherein the accessing and constructing steps of claim 1 are performed by a variability engine component of the text-to-speech system, wherein the variability engine utilizes the finite state grammar to vary one or more phrase elements of the text phrase, whereby producing a larger variety of speech output for a single action command.

9. The method of claim 1, wherein said steps of claim 1 are performed by at least one machine in accordance with at least one computer program stored in a computer readable media, said computer programming having a plurality of code sections that are executable by the at least one machine.

10. A text-to-speech system that provides output variability comprising:
a finite state grammar comprising a phrase rule consisting of one or more phrase elements, wherein the phrase rule deterministically generates a variable text phrase upon receiving at least one random number and an action command, the finite state grammar can also comprise a plurality of definitions, one for each phrase element, wherein each definition is associated with at least one text string, wherein the variable text phrase is generated by concatenating a plurality of the text strings together in accordance with the phrase rule;
a variability engine configured to construct a random text phrase responsive to receiving an action command, wherein said finite state grammar is used to create the text phrase; and
a speech-to-text engine configured to convert the text phrase generated by the variability engine into speech output.

11. The system of claim 10, wherein the variability engine further comprises:
a number generator configured to generate a numeric value, wherein the generated numeric value corresponds to one of the text strings defined for the phrase element; and
a weight applicator configured to adjust a selection of the text string based upon weighting data.

12. The system of claim 11, wherein die weighting data contains a weight value for each text string of the phrase element definition, and wherein the weight value is one of a numeric value and a range of numeric values.

13. The system of claim 11, wherein the number generator is one of a pseudo-random number generating algorithm, a quasi-random number generating algorithm, and a physical random number generator.

14. A speech synthesis method comprising:
receiving a command for generating speech;
determining one of a plurality of finite state grammars that is associated with the received command, wherein the finite state grammar comprises a plurality of phrase elements, each element corresponding to a plurality of different text strings;
randomly generating at least one number, which is used to select one of the different text strings for each of the phrase elements:
concatenating the selected text strings in an order determined by the finite grammar; and
text-to-speech converting the concatenated text strings to produce synthesized speech output.

15. The method of claim 14, wherein the at least one randomly generated number is a plurality of randomly generated numbers, each randomly generated number corresponding to one of the phrase elements.

16. The method of claim 14, further comprising:
associating at least one weight to at least one of the text strings, wherein the associated weight causes one of the text strings of a phrase element to be selected more often than another of the text strings of the phrase element.

17. The method of claim 16, wherein the receiving, determining, generating, concatenating, and converting steps are automatically performed by a machine in accordance with a set of programmatic instructions stored in a machine readable medium.

18. The method of claim 17, wherein the set of programmatic instructions are part of a text-to-speech engine used by a turn-based speech processing system.

19. The method of claim 17, wherein the set of programmatic instructions are part of a text-to-speech engine residing within a stand-alone computing device having speech generation capabilities, said method being performed by tire computing device.
